(19) United States
(12) Patent Application Publication
(10) Pub. No.: US 2007/0090324 A1
(43) Pub. Date: Apr. 26, 2007

(54) Antifreeze/liquid coolant composition and method of use

(76) Inventor: Virgil Flanigan, Rolla, MO (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/255,262

(22) Filed: Oct. 21, 2005

(51) Int. Cl. C09K 5/00

(52) U.S. Cl. 252/71

(57) ABSTRACT

The present invention relates to an engine antifreeze coolant composition that is non-hazardous. More particularly, the invention is related to an anti-freeze coolant formed from a mixture of glycerine, an anti-oxidant, and a boron film former.

### FIELD OF INVENTION

The present invention relates to an engine antifreeze coolant composition that is non-hazardous. More particularly, the invention is related to an anti-freeze coolant formed from a mixture of glycerine, an anti-oxidant, and a boron film former.

### BACKGROUND OF INVENTION

Since the advent of the horseless carriage equipped with a liquid cooled internal combustion engine, antifreeze coolant fluids have been used to protect against winter freezing of the coolant and to aide in the transfer of heat, to cool the engine. Antifreeze is characterized by a good heat load capacity, which functions to lower the internal temperature of the engine by carrying heat from within the combustion chamber away from the engine, to the heat exchangers, such as radiators or heat cores. Without this transfer of heat the engine would overheat causing damage to the engine and eventual engine failure. Further, antifreeze either alone or when mixed with water produces a mixture with a lowered freezing point, which allows the engine coolant system to operate under extreme low temperature conditions.

Desired characteristics for an antifreeze fluid have evolved as engines have advanced. Current exhaust gas recirculating (EGR) technology requires that the antifreeze not only operates to transfer heat, but also, that the antifreeze have temperature stability characteristics. Temperature stability ensures that the antifreeze will function with an extended life over a wide temperature range and not break down due to the extreme temperature conditions. Additionally, the antifreeze, must minimize corrosion, scale, and rust formation, which can lead to pitting and cavitation erosion within the engine coolant system.

Conventional antifreezes are composed of numerous components that are typically hazardous to humans and the environment. One of the main components of antifreeze includes ethylene glycols or propolyene glycols. Glycols exhibit good heat load capacity to aid in the transfer of heat and have a low freezing point that ensures the fluid coolant is protected against winter freezing. Unfortunately, glycols are considered extremely hazardous to the environment, and in certain instances require a special disposal process. Additional supplemental coolant additives (SCA), are added to current antifreeze fluids, to limit engine problems such as pitting, cavitation erosion, production and collection of scale, rust, or other contaminants, and to increase heat transfer and lower the freezing point of the antifreeze fluid. Currently, SCA include nitrates, nitrites, tolytriazole, benzotriazole, and mercaptobensothiazole, all of which are carcinogenic. Therefore, current antifreezes found on the market are hazardous to the environment, and in some cases carcinogenic.

It is therefore desirable to have an antifreeze composition for use with EGR technology with properties such as: 1) environmentally safe; 2) provides good heat transfer; 3) temperature stable; 4) chemical stable; 5) protects and inhibits corrosion, scale, pitting, cavitation erosion, rust, and other contamination formations; 6) aides in filtration of contaminants; and, 7) does not contain hazardous SCA.

### SUMMARY OF INVENTION

The present invention relates to an antifreeze composition that operates as a coolant fluid for use in engine cooling systems. The antifreeze includes glycerine and chemical additives. Water is optionally added to the glycerine in an amount sufficient to produce a ratio of 1 part water to 2 parts glycerine to form the base fluid of the antifreeze. Chemical additives function as performance enhancing additives to produce an antifreeze with specific characteristics dependent on the desired environment under which the antifreeze will perform. Chemical additives include stabilizers, film formers, defoamers, and wetting agents. Stabilizers are typically anti-oxidants that are particularly suited to enhance temperature stability and increase the life of the antifreeze composition. Examples of stabilizers include butylated hydroxy toluene, butylated hydroxy anisols, tertiary hydroquinone, ply(p-hydroxystyrene), pyrogallol, s-methoxycatechol, 2,3-dimethoxyphenol, and combinations thereof. Film formers, which include boron based additives, aid in the prevention of scale, rust, or reactive chemical components from adhering to the cooling system. Optionally, wetting agents and defoamers are included in the antifreeze composition to limit pitting and cavitation corrosion.

The present invention also relates to a method of using the antifreeze composition described above with an engine cooling system for cooling of engines, such as EGR engines. The antifreeze is used with an engine's cooling system to transfer heat away from the engine ensuring optimum engine performance. Any amount of the antifreeze can be used with the cooling system so long as heat is transferred away from the engine and the cooling system operates over a wide temperature range, including extreme low temperatures.

The present invention provides an antifreeze composition that is temperature stable, provides good heat transfer, and protects the cooling system from corrosion, scale, pitting, and other contaminants. Further, the antifreeze is environmentally friendly because all components are non-hazardous.

### DETAILED DESCRIPTION

The present invention relates to an antifreeze composition and a method of using the composition. The fluid is particularly suited for use as an internal combustion engine coolant. The coolant includes glycerine, a stabilizer, a film former, and additional additives.

One component of the antifreeze composition is glycerine, which is generally an alcohol with three hydroxyl groups. Glycerine is an environmentally friendly compound that is non-hazardous, temperature stable, and has a positive heat load capacity. Glycerine when combined with water results in a good heat load capacity mixture with a lowered freezing point. The glycerine is added in a concentration sufficient to ensure good heat load capacity, and peak performance dependent on the environment under which the antifreeze will perform

Optionally, water can be added to the antifreeze composition. Preferably, the water is demineralized. A sufficient amount of water is added to provide an antifreeze that is temperature stable, has a high load capacity, and a low freezing point. Preferably, the water is added in an amount sufficient to produce a ratio of 1 part water to 2 parts glycerine.

A second component of the antifreeze is a stabilizer. The stabilizer is an anti-oxidant that enhances temperature stability, adds chemical stability, and increases the life of the antifreeze composition. The anti-oxidant enhances the stability of the antifreeze composition by reducing the oxidation that typically occurs to the glycerine. By reducing the oxidation of the glycerine the resultant acid production, typically caused in the cooling system when oxidation of the glycerine occurs, is reduced. The anti-oxidant is also an environmentally safe ingredient that is non-hazardous. Preferred anti-oxidants that can be used in the present invention include but are not limited to butylated hydroxy toluene, butylated hydroxy anisols, tertiary hydroquinone, ply(p-hydroxystyrene), pyrogallol, s-methoxycatechol, 2,3-dimethoxyphenol, and combinations thereof. The anti-oxidant will be present in concentrations that ensure peak performance dependent on the environment under which the antifreeze will perform.

The third component of the antifreeze composition is a film former additive. It is particularly suited for use in the present antifreeze composition because it prevents scale, rust, or reactive chemical components from adhering to the cooling system. The film former functions to hold any contaminant in suspension by encapsulating the contaminant, whereby allowing the contaminant to flow in the antifreeze composition until it is captured by the engine coolant filter. Preferably, the film former is a boron based additive. Boron based additives are known in the industry and commercially available. An example of a commercially available boron additive is described in U.S. Pat. No. 5,431,830 assigned to Arch Development Corp.

The film former additive is added in an amount sufficient to ensure a film is present to aid in the reduction of contaminants within the cooling system. Preferably, the film former is present in the antifreeze in an amount equal to about 5,000 to 30,000 part per million (ppm).

Optionally, a defoaming and wetting additive is added to the antifreeze composition. The defoaming and wetting additive is a performance enhancing additive. It is an additive that functions to protect the cooling system from cavitation corrosion and pitting. Whereby, extending the life of the cooling system.

The mixture of the glycerine, stabilizer, and film former produce an anti-freeze composition with characteristics that are specifically designed to endure the extreme conditions found in engines, such as EGR engines. The present invention of the antifreeze composition exhibits characteristics, such as temperature stability, a high heat load capacity, inhibition of corrosion and scale, and the capture of contaminants. In addition the present invention is environmentally safe because it does not use hazardous SCAs or other additives or components which are hazardous to the environment.

Thus, there has been shown and described an antifreeze coolant composition and method for its use that fulfills all objects and advantages sought therefore. The invention illustratively disclosed herein suitably may be practiced in the absence of any element which is not specifically disclosed herein. It is apparent to those skilled in the art, however, that many changes, variations, modification, other uses, and applications to the fluid lubricant are possible, and also such changes, variations, modifications, other uses, and application which do not depart from the sprit and scope of the invention are deemed to be covered by the invention, which is limited only by the claims which follow.

What is claimed is:

1. An antifreeze coolant composition comprising;
(a) glycerine;
(b) a stabilizer; and,
(c) a film former.

2. The coolant composition of claim 1, wherein the stabilizer is an anti-oxidant.

3. The coolant composition of claim 2, wherein the anti-oxidant is selected from the group consisting of butylated hydroxy toluene, butylated hydroxy anisols, tertiary hydroquinone, ply(p-hydroxystyrene), pyrogallol, s-methoxycatechol, 2,3-dimethoxyphenol, and combinations thereof.

4. The composition of claim 1, wherein the film former is a boron additive.

5. The composition of claim 1, wherein the composition contains a defoaming agent.

6. The composition of claim 1, wherein the composition contains a wetting agent.

7. The composition of claim 1, wherein the composition further includes water.

8. The composition of claim 7, wherein the water is demineralized water.

9. The composition of claim 7, wherein the ratio of water to glycerine is 1 part water to 2 parts glycerine.

10. The composition of claim 1, wherein the composition contains between 5,000 to 30,000 parts per million film former.

11. The composition of claim 1, wherein the composition does not contain hazardous components.

12. A method for cooling the engine, comprising supplying to the engine cooling system an antifreeze composition comprising glycerine, a stabilizer, and a film former.

13. The method of claim 12, wherein the antifreeze further comprises water.

14. The method of claim 12, wherein the stabilizer is an anti-oxidant.

15. The method of claim 12, wherein the anti-oxidant is selected from the group consisting of butylated hydroxy toluene, butylated hydroxy anisols, tertiary hydroquinone, ply(p-hydroxystyrene), pyrogallol, s-methoxycatechol, 2,3-dimethoxyphenol, and combinations thereof.

16. The method of claim 12, wherein the film former is a boron additive.

17. The method of claim 12, wherein the antifreeze further comprises a defoaming agent.

18. The method of claim 12, wherein the antifreeze further comprises a wetting agent.

19. The method of claim 12, wherein the antifreeze does not contain hazardous components.

20. A non-hazardous antifreeze coolant composition comprising:
(a) glycerine;
(b) an anti-oxidant selected from the group consisting of butylated hydroxy toluene, butylated hydroxy anisols, tertiary hydroquinone, ply(p-hydroxystyrene), pyrogallol, s-methoxycatechol, 2,3-dimethoxyphenol, and combinations thereof stabilizer; and,
(c) a boron additive; and
(d) water.

21. The composition of claim 20, wherein the composition contains a defoaming agent.

22. The composition of claim 20, wherein the composition contains a wetting agent.
